(19) United States
(12) Patent Application Publication
(10) Pub. No.: US 2007/0181767 A1
(43) Pub. Date: Aug. 9, 2007

(54) Foundation for a wind energy plant

(76) Inventor: Aloys Wobben, Aurich (DE)

Correspondence Address: SEED INTELLECTUAL PROPERTY LAW GROUP PLLC, 701 FIFTH AVE, SUITE 5400, SEATTLE, WA, 98104, US

(21) Appl. No.: 10/556,421

(22) PCT Filed: May 8, 2004
(86) PCT No.: PCT/EP04/04939

§ 371 Date: Dec. 22, 2006

(30) Foreign Application Priority Data
May 13, 2003 (DE) 103 21 647.2

(51) Int. Cl. A47B 91/00; F16M 5/00

(52) U.S. Cl. 248/346.01; 248/678

(57) ABSTRACT

A foundation for a wind power installation including prefabricated elements which are important for the statics of the foundation of the wind power installation, namely the load-bearing and laterally stabilizing elements of the foundation. In an embodiment the foundation prefabricated elements include a foundation base element and at least two foundation foot modules, adapted to be fixed to the foundation base element.

The present invention concerns a foundation for a wind power installation and a wind power installation having a foundation of that kind.

In wind power installations the foundation and the dimensioning thereof is of very great significance as wind power installations of that kind are very heavy and are subjected to very high loadings.

Hitherto the foundations for wind power installations have been produced essentially by digging out an excavation, introducing a granular subbase, erecting a foundation installation component, carrying out the necessary reinforcing works and then filling the excavation with cement, wherein the cement is transported to the necessary location by means of cement loaders and poured into the excavation. The foundation installation component is usually of a hollow-cylindrical configuration and is generally prefabricated and is transported as a unit to the respective assembly location.

As state of the art attention is directed in this matter inter alia to DE 40 37 438 C2, DE 33 36 655 A1, DE 76 37 601 U, FR 1 015 719, U.S. Pat. No. 4,714,255 A, EP 1 074 663 A1, WO 94/26986 A1 and WO 00/46452 A1.

Filling the excavation with the required concrete is found to be not without its problems, in particular under adverse weather conditions, while in contrast the operation of digging out the excavation for the foundation can be effected under almost any weather conditions. The quality of the finished hardened concrete is highly dependent on the weather conditions.

Therefore the object of the invention is to provide a foundation for a wind power installation, the quality of which is ensured substantially irrespective of the prevailing weather conditions upon installation.

That object is attained by a foundation for a wind power installation as set forth in claim 1.

In that respect the invention is based on the idea of first producing the elements which are important for the structural engineering of the foundation of the wind power installation.

That is particularly advantageous insofar as elements of that kind can be produced in a factory under precisely defined temperature and air humidity conditions, and that substantially increases the quality of the end product. In addition the required quality control can already be carried out in the factory so that it no longer has to be carried out on site, at the respective installation localities. In addition the elements of the foundation can be produced in a factory more efficiently and less expensively, if they are manufactured on a mass-production basis.

In accordance with a configuration of the invention the foundation has a foundation base element 20 and at least two foundation foot modules 10, wherein the foot modules can be fixed to the base element and wherein the base element 20 and the at least two foot modules 10 represent prefabricated elements. By virtue of the fact that the foundation is no longer in one piece but comprises a plurality of elements, those elements can be separately transported and installed on site, in which case the quality achieved by manufacture in a factory is not adversely affected. As the elements of the foundation are of not inconsiderable dimensions, transport just of the individual elements is substantially easier.

In a further configuration of the invention the foundation base element is of a hollow-cylindrical configuration and the foundation foot modules 10 are oriented radially with respect to the axis of symmetry of the foundation base element. The radial orientation of the foot modules ensures the necessary statics of the foundation as the foot modules can be mounted around the base element, as required. In addition the foot modules can be fixed in the cavity of the base element by suitable fixing means.

In a particularly preferred configuration of the invention the foot module has a respective foot plate and a foot support element which are respectively arranged radially with respect to the axis of symmetry of the base element. In that case the foot support element is perpendicular to the foot plate while the foot plate in the fixed condition is arranged substantially perpendicularly to the axis of symmetry of the base element. The static forces acting on the wind power installation are better transmitted to the supporting ground by the foot plate and the support element.

In a further configuration of the invention the height of the support element decreases radially outwardly. That tapering of the support element outwardly also serves to provide improved statics.

In a further configuration of the invention the width of the foot plate becomes radially outwardly larger, which also serves for improved statics.

In a further configuration of the invention both the support elements and also the foot plates have radially oriented through holes. The base element has corresponding through holes so that the foot modules can be fixed to the base element for example by means of suitable fixing means, by means of those through holes.

In a further configuration of the invention the foot plates and/or the support elements have further through holes of a diameter which makes it possible for lashing straps to be passed through them during transport in order securely to fix the foot modules.

In a particularly preferred configuration of the invention the base element and the foot modules comprise steel-reinforced concrete.

The invention is described in greater detail hereinafter with reference to the drawing in which:

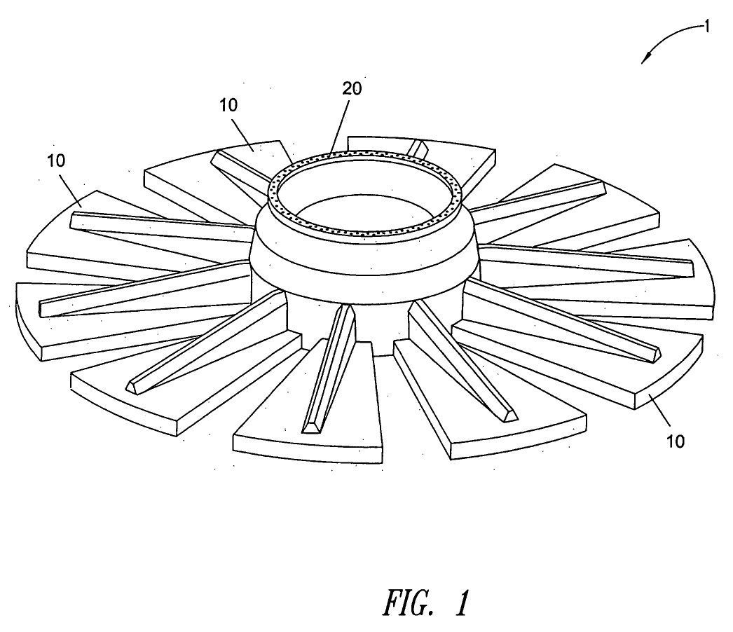

FIG. 1 shows a perspective view of a foundation according to a first embodiment,

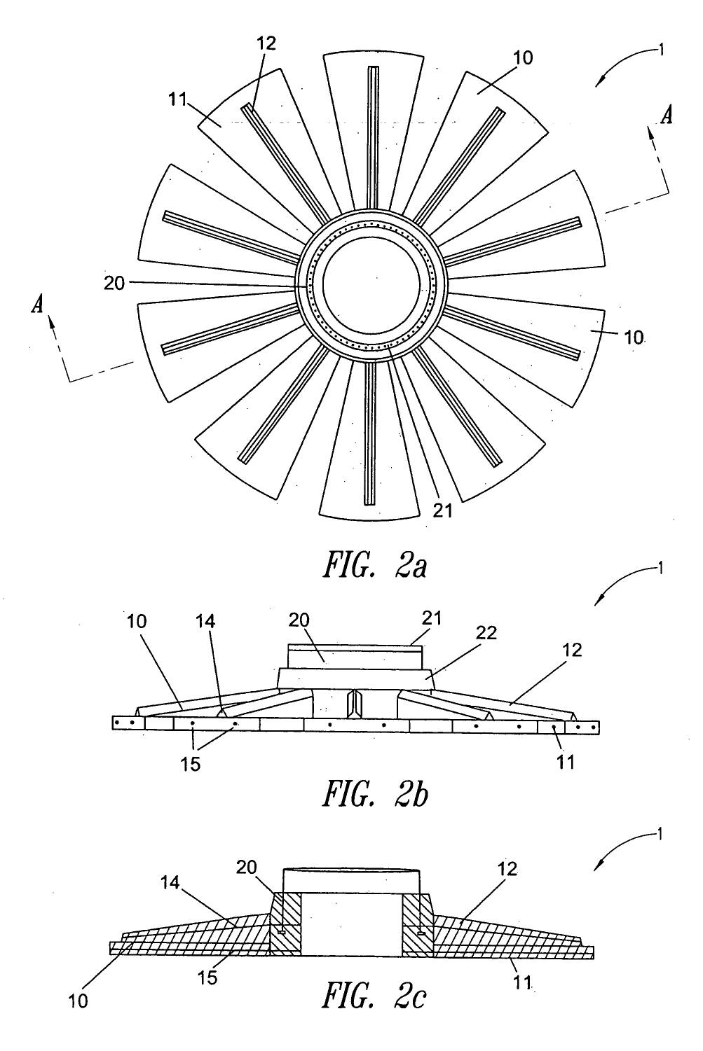

FIGS. 2a to c show various views of the foundation of FIG. 1,

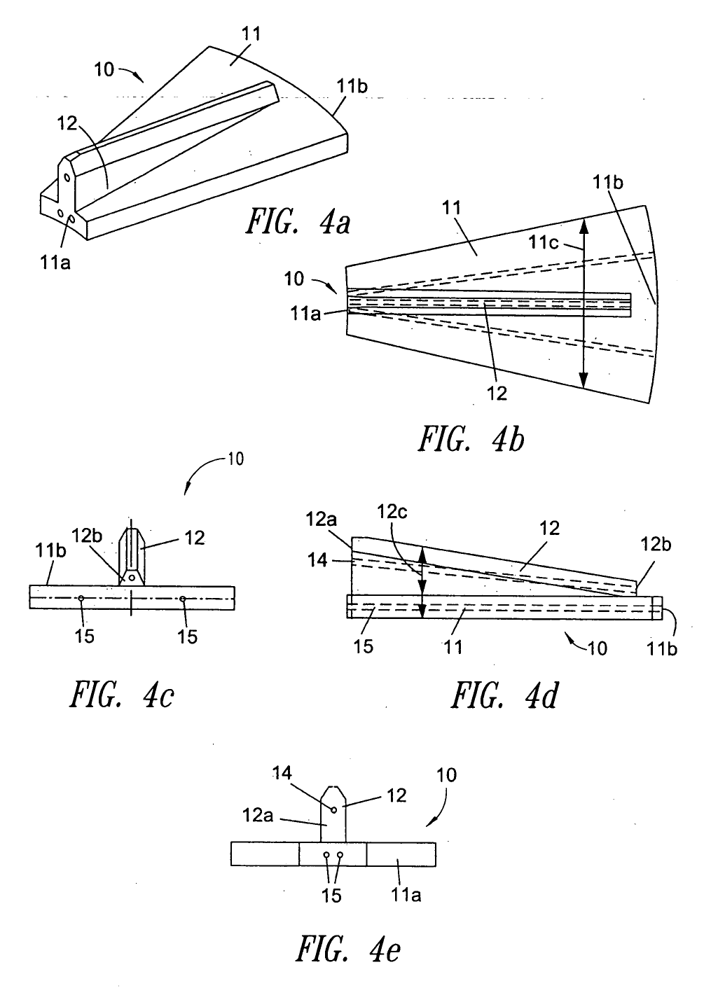

FIGS. 4a to e show various views of a foundation foot,

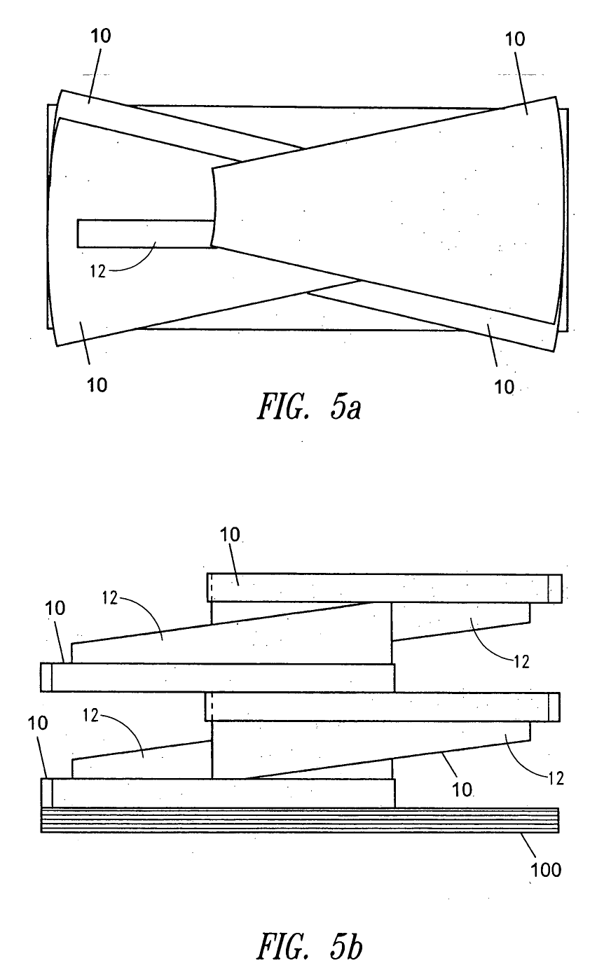

FIGS. 5a and b show a plan view and a side view of foundation feet as shown in FIG. 4a, which are stacked for transport thereof,

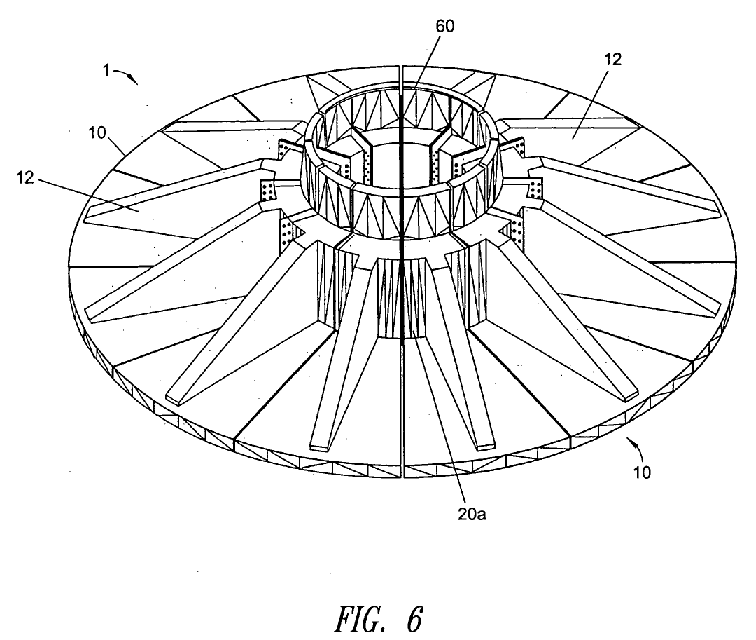

FIG. 6 shows a perspective view of a foundation in accordance with a second embodiment,

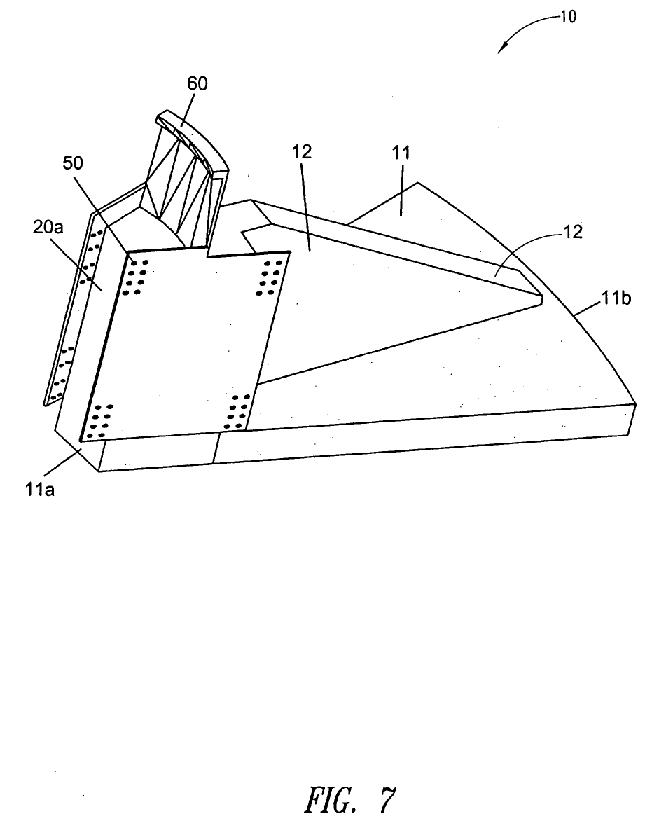

FIG. 7 shows a perspective view of an element of the foundation of FIG. 6, and

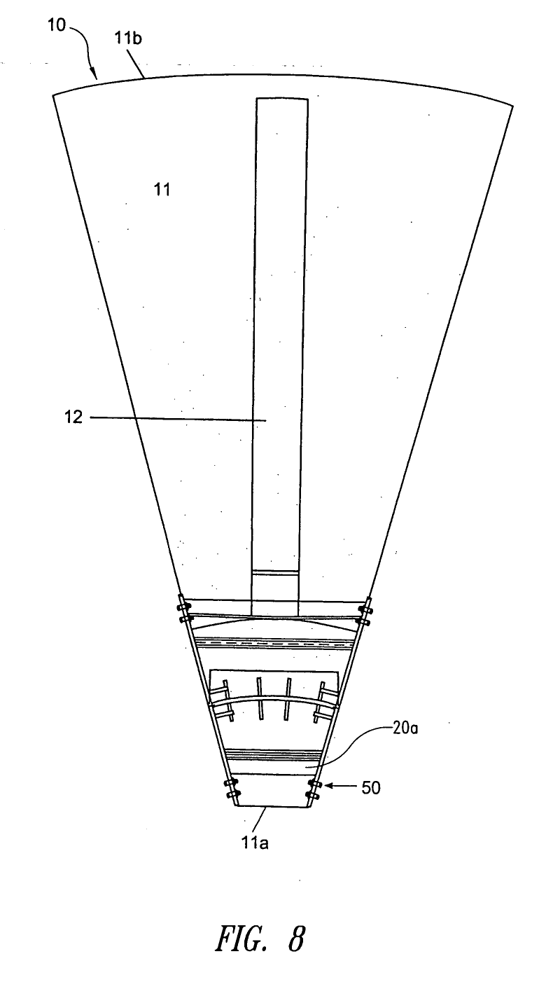

FIG. 8 shows a plan view of an element of the foundation of FIG. 6.

FIG. 1 shows a perspective view of the foundation in accordance with a first embodiment of the invention. In this case the foundation 1 substantially comprises a hollow-cylindrical base element 20 and a plurality of foot modules 10 which are oriented radially with respect to the longitudinal axis or axis of symmetry of the base element 20, distributed uniformly around its periphery.

FIG. 2a shows a plan view of the foundation of FIG. 1. Arranged around the periphery of the hollow-cylindrical base element 20 are a plurality of holes 21. Those holes are intended to serve to receive fixing elements, by means of which a pylon of a wind power installation can be fixed on the foundation 1. The foot modules 10 comprise a foot plate 11 and a support element 12. The various foot modules 10 are respectively spaced from each other at 36° so that 10 foot elements can be fixed around the base element 20. It will be appreciated that both more and also fewer foot modules can be arranged around the base element 20 in order to ensure the necessary static requirements.

FIG. 2b shows a side view of the foundation of FIG. 1. In this case the foot plates 11 of the foot modules 10 are arranged in one plane and perpendicularly to the axis of symmetry of the hollow-cylindrical base element 20. The support elements 12 are also oriented perpendicularly to the foot plate 11 and radially to the axis of symmetry of the base element 20, with the support element 12 being arranged in centered relationship on the foot plate 11. The base element 20 has a lower portion 22 of a larger thickness than the upper portion on which the holes 21 are provided.

FIG. 2c shows a view in section taken along line A-A in FIG. 2b. In this case the thickness of the foot plate 11 is substantially constant while the height of the support element 12 decreases outwardly. A respective radially oriented through hole 14 is provided in the support element 12. Provided in the foot plate 11 are two through holes 15 which are also oriented radially with respect to the axis of symmetry. Those through holes 14 and 15 serve in that case to provide that the foot modules 10 can be mounted to the base element 20 for example by fixing means.

FIGS. 4a to e show views of the foot module 10 from FIG. 2a. In this respect 4a shows a perspective view of the foot module 10 with the foot plate 11 and the support element 12 arranged perpendicularly thereto. In this arrangement the foot plate has an inside 11a and an outside 11b. The foot module 10 is mounted to the base element 20 with the inside 11a of the foot plate 11.

FIG. 4b shows a plan view of the foot module 10 of FIG. 4a. The width 11c of the foot plate 11 decreases outwardly. In addition both the inside 11a and also the outside 11b of the foot plate are of a curved configuration. In this case the curvature of the inside 11a of the foot plate 11 is adapted to the external curvature of the base element 20 so that the foot module 10 can be lockingly fixed to the base element 20.

FIG. 4c shows a side view of the foot module 10 of FIG. 4a, that view illustrating the outside of the foot module 10. In particular in this case the outside 11b of the foot plate 11 and the outside 12b of the support element 12 and the two through holes 15 in the foot plate 11 are illustrated here.

FIG. 4d shows a side view of the foot module 10 of FIG. 4a. In this case the height 12c of the support element 12 decreases from the inside 12a of the support element 12 towards the outside 12b thereof. In addition the Figure shows the through holes 14 in the support element 12 and the through holes 15 in the foot plate 11.

FIG. 4e shows the side of the foot module 10, which is towards the base element 20. In this case also the Figure shows the through holes 14 in the support element 12 and the through holes 15 in the foot plate 11.

By virtue of the size of the foot modules 10 which can be over 5 m, transport of such foot modules represents a further problem to be resolved. FIGS. 5a and 5b show a transport arrangement for a plurality of foot modules 10. In this case the various foot modules are stacked one upon the other, more specifically in such a way that the support elements 12 of two foot modules 10 are in mutually opposite relationship. For example in that way 4 foot modules 10 are fixed on a pallet 100. The foot modules 10 are respectively stacked in mutually displaced relationship by virtue of the centered arrangement of the support elements 12.

In order to make the transport of such foot modules secure, the foot modules 10 can optionally be provided with further through holes. In that case those through holes should be of such a configuration that commercially available lashing straps can be passed therethrough so that the foot modules 10 can be securely fixed. The provision of such through holes does not represent a major problem in manufacture of the foot modules 10 as the holes can be readily drilled in the factory or suitable casting moulds can be provided. The statics of the foot modules 10 are not adversely affected by such through holes.

Optionally alignment elements can be provided beneath some of the foot plates 11 or between the foot modules 10 and the base element 20 in order to ensure accurate horizontal orientation of the foundation.

Transport of the base elements 20 of the foundation 1 of a wind power installation has already long been known and is not subject-matter of the present application.

By virtue of the modular structure of the foundation of a wind power installation in accordance with the illustrated embodiment of the invention it is possible for both the base element 20 and also the foot modules 10 to be previously manufactured in a factory and then transported to the installation location. That pre-fabrication in a factory ensures that the foundations for the wind power installations are of a uniform quality. In addition the foundation of a wind power installation can be laid under almost any weather conditions. For that purpose, as is known from the state of the art, firstly an excavation is dug and possibly a granular subbase layer laid. Then the base element 20 is installed and the foot modules 10 are fixed to the base element 20 by means of suitable fixing means. The foundation can subsequently be reinforced, and then the excavation can be filled with concrete. In that respect the quality of that concrete is secondary as the statically important elements of the foundation, namely the base element and the foot modules, have been pre-fabricated.

FIG. 6 shows a perspective view of a complete foundation in accordance with a second embodiment. In contrast to the foundation in accordance with the first embodiment the foundation of the second embodiment does not have a hollow-cylindrical base element around which a plurality of foot modules are arranged. Rather, each foot module has a segment portion of the base element. In other words, the hollow-cylindrical base element is divided into a plurality of portions which are each a respective constituent part of the foot module 10. Furthermore each foot module 10 has a flange portion 60 which is again provided with the through holes in order to fix the corresponding pylon segments of a wind power installation thereto.

FIG. 7 shows a perspective view of an individual foot module 10 in accordance with the second embodiment. The foot module again has a foot plate 11 and a support element 12 as well as a base element portion 20a. Provided on the base element 20a are holes 15 which are intended to serve to connect the foot modules together. The connection between the foot modules 10 can be effected by means of suitable screw connections or also other connections. Also provided on the base element portion is a flange portion 60 for fixing corresponding pylon segments.

FIG. 8 shows a plan view of a foot module 10 of FIG. 6 or FIG. 7. The width of the foot modules 10 or the foot plates 11 essentially depends in this case on the number of foot modules 10 provided. Installation of the provided number of foot modules thus affords a complete circular foundation with a foundation section, which is already integrated, for a wind power installation. To improve the connections between the various foot modules 10 lateral plates can be arranged on the base element portions 20a. FIG. 8 shows inter alia the screws for connecting the respective foot modules 10 as well as the anchorage of the base element of the foundation section in the foot element (left-hand part of FIG. 8).

As in the case of the foundation of the first embodiment, the foundation in accordance with the second embodiment can be manufactured beforehand so that the foundation or the foot modules have to be assembled at the installation location.

As a loading crane is usually already on site for assembly of the wind power installation, that crane can be used to lift the elements of the finished foundation into the excavation.

Although the finished foundation according to the invention has been described here for use on land, it will be appreciated that it can also be used in relation to foundations for offshore wind power installations.

Insofar as wind power installations are mentioned in the present application, that means in particular that they are wind power installations which assume a given order of magnitude, that is to say for example a nominal power in the range of about 300 kW to 2 MW, preferably 600 kW, and in that respect involve a hub height (that is to say pylon height) of about 45 to 85 m. The present application is particularly well suited for constructing a wind power installation from Enercon of Type E40 or E66 with the known pylon or hub heights and power data.

1. A foundation for a wind power installation, comprising:
a foundation base element, and
at least two foundation foot modules, wherein the foundation foot modules are adapted to be fixed to the foundation base element,
wherein the foundation base element and the at least two foundation foot modules represent prefabricated elements,
wherein the foundation base modules each have a foot plate and a foot support element which are respectively arranged radially with respect to the axis of symmetry of the foundation base element, and
wherein the foot support element is arranged perpendicularly to the foot plate and the foot plates in the fixed condition are arranged substantially perpendicularly to the axis of symmetry of the foundation base element.

2. (canceled)

3. A foundation according to claim 1
wherein the foundation foot modules are adapted to be fixed together and represent prefabricated elements.

4. A foundation according to claim 1 wherein the foundation base element is of a hollow-cylindrical configuration and the foundation foot modules are oriented radially with respect to the axis of symmetry of the foundation base element.

5. (canceled)

6. A foundation according to claim 4 wherein the height of the foot support elements decreases radially outwardly.

7. A foundation according to claim 4 wherein the width of the foot plate increases radially outwardly.

8. A foundation according to claim 4 wherein the foot modules have radially oriented through holes for receiving fixing means, and
wherein the foot base element has through holes matched to the through holes in the foot modules.

9. A foundation according to claim 1 wherein the foot plates and/or the foot support elements have further through holes which are suitable for receiving lashing straps during transport.

10. A foundation according to claim 1 wherein the foundation base element and the at least two foundation foot modules are prefabricated from steel-reinforced concrete.

11. A foundation according to claim 3 wherein the foundation foot module has a base element portion which is arranged at one end of the foot plate perpendicularly thereto.

12. A foundation for a wind power installation, comprising a plurality of prefabricated foundation foot modules, wherein each foundation foot module has a base element segment for connecting the foundation foot modules to each other, a foot plate and a foot support element,
wherein the foot support element and the base element segment are respectively arranged perpendicularly to the foot plate, and
wherein the base element segment has a flange segment for fixing pylon segments of a wind power installation.

13. A foundation according to claim 12 wherein the height of the foot support elements decreases radially outwardly.

14. A foundation according to claim 12 wherein the width of the foot plate increases radially outwardly.

15. A foundation according to claim 12 wherein at least one of the foot plates and/or the foot support elements have through holes which are suitable for receiving lashing straps during transport.

16. A wind power installation comprising a foundation, wherein the foundation includes:
a foundation base element, and
at least two foundation foot modules, wherein the foundation foot modules are adapted to be fixed to the foundation base element,
wherein the foundation base element and the at least two foundation foot modules represent prefabricated elements,
wherein the foundation base modules each have a foot plate and a foot support element which are respectively arranged radially with respect to the axis of symmetry of the foundation base element, and
wherein the foot support element is arranged perpendicularly to the foot plate and the foot plates in the fixed condition are arranged substantially perpendicularly to the axis of symmetry of the foundation base element.
